(19) United States
(12) Patent Application Publication
(10) Pub. No.: US 2025/0309441 A1
(43) Pub. Date: Oct. 2, 2025

(54) CELL STACK AND METHOD OF MANUFACTURING THE SAME

(71) Applicant: TOYOTA JIDOSHA KABUSHIKI KAISHA, Toyota-shi (JP)

(72) Inventors: Takayuki SUGIYAMA, Toyota-shi (JP); Motokuni Maruhashi, Toyota-shi (JP); Hiromasa Tanaka, Okazaki-shi (JP); Akio Uotani, Toyota-shi (JP); Kazuya Kumazawa, Noagya-shi (JP)

(73) Assignee: TOYOTA JIDOSHA KABUSHIKI KAISHA, Toyota-shi (JP)

(21) Appl. No.: 19/069,345

(22) Filed: Mar. 4, 2025

(30) Foreign Application Priority Data
Mar. 29, 2024 (JP) 2024-055749

(51) Int. Cl. H01M 50/242; H01M 50/209; H01M 50/291; H01M 50/293

(52) U.S. Cl. CPC H01M 50/242; H01M 50/209; H01M 50/291; H01M 50/293; H01M 2220/20

(57) ABSTRACT

A cell stack includes a plurality of rectangular cells that are stacked and a plurality of intercell members inserted between the adjacent rectangular cells, the cell stack having a rectangular parallelepiped shape. The plurality of the intercell members include: a first intercell member including a plate-like spacer for absorbing variations in thicknesses of the plurality of rectangular cells, and a second intercell member not including the plate-like spacer. The plate-like spacer is made of hard plastic and has a uniform thickness, and the first intercell member and the second intercell member are arranged at irregular intervals.

### CROSS REFERENCE TO RELATED APPLICATIONS

This application is based upon and claims the benefit of priority from Japanese patent application No. 2024-055749, filed on Mar. 29, 2024, the disclosure of which is incorporated herein in its entirety by reference.

### BACKGROUND

The present disclosure relates to a cell stack and a method of manufacturing the same.

In the conventional cell stack, terminals are provided on an upper surface of each stacked rectangular cell. Recently, a cell stack has been developed in which terminals are provided on an end surface of each stacked rectangular cell in the longitudinal direction, as disclosed in Patent Literature 1.

Patent Literature 1: United States Patent Publication No., 2022/0302533

### SUMMARY

Stacked rectangular cells in a cell stack have a predetermined dimensional tolerance denoted by ±b with respect to a design thickness denoted by a. That is, the thicknesses of the rectangular cells are a±b. Until now, the inventors have selectively inserted two kinds of plate-like spacers made of an elastic material such as elastomer containing synthetic rubber and having different thicknesses between all adjacent rectangular cells in order to absorb variations in the thicknesses of the rectangular cells.

However, since an elastic material is costly and two kinds of plate-like spacers having different thicknesses are used, there is a problem that manufacturing becomes intricate.

The present disclosure has been made in view of such circumstances, and provides a cell stack which can be manufactured more cost-savingly and easily.

According to an aspect of the present disclosure, a cell stack includes:
a plurality of rectangular cells that are stacked; and
a plurality of intercell members inserted between the adjacent rectangular cells, the cell stack having a rectangular parallelepiped shape,
in which the plurality of the intercell members include:
a first intercell member including a plate-like spacer for absorbing variations in thicknesses of the plurality of rectangular cells; and
a second intercell member not including the plate-like spacer,
in which the plate-like spacer is made of hard plastic and has a uniform thickness, and
in which the first intercell member and the second intercell member are arranged at irregular intervals.

According to the present disclosure, the plurality of the intercell members inserted between the adjacent rectangular cells include: a first intercell member including a plate-like spacer for absorbing variations in thicknesses of the rectangular cells; and a second intercell member not including the plate-like spacer, in which the plate-like spacer is made of hard plastic and has a uniform thickness, and in which the first intercell member and the second intercell member are arranged at irregular intervals. That is, one kind of plate-like spacer made of inexpensive hard plastic and having a uniform thickness is inserted at irregular intervals between the adjacent rectangular cells, thereby variations in the thicknesses of the rectangular cells are absorbed. Accordingly, a cell stack which can be manufactured more cost-savingly and easily can be provided.

Each of the first and second intercell members may include a heat insulating plate having a uniform thickness. With such a configuration, all adjacent rectangular cells can be heat-insulated from each other.

The thickness of the plate-like spacer may be equal to a dimensional tolerance range of the thickness of an individual rectangular cell of the plurality of rectangular cells. With such a configuration, variations in the thicknesses of the rectangular cells can be easily absorbed only by insertion or non-insertion of the plate-like spacer.

A method of manufacturing a cell stack having a rectangular parallelepiped shape in which rectangular cells and intercell members are sequentially stacked, including:
each time a rectangular cell is to be stacked, measuring a thickness of the rectangular cell to be stacked;
making a determination as to whether a total thickness calculated by adding the measured thickness of the rectangular cell to be stacked to thicknesses of the already-stacked rectangular cells and the intercell members exceeds a predetermined reference value;
in the case where the total thickness does not exceed the predetermined reference value, inserting a first intercell member including a plate-like spacer for absorbing variations in the thicknesses of the rectangular cells as an intercell member, and then stacking the rectangular cell to be stacked; and
in the case where the total thickness exceeds the predetermined reference value, inserting a second intercell member not including the plate-like spacer as the intercell member, and then stacking the rectangular cell to be stacked,
in which the plate-like spacer is made of hard plastic and has a uniform thickness.

In a cell stack manufacturing method according to the present disclosure, each time a rectangular cell is to be stacked, a thickness of the rectangular cell to be stacked is measured, and a determination is made as to whether a total thickness calculated by adding the measured thickness of the rectangular cell to be stacked to the thicknesses of the already-stacked rectangular cells and the plate-like spacer exceeds a predetermined reference value. In the case where the total thickness does not exceed the predetermined reference value, the plate-like spacer is inserted and then the rectangular cell to be stacked is stacked, and in the case where the total thickness exceeds the predetermined reference value, the rectangular cell to be stacked is stacked without inserting the plate-like spacer. Here, the plate-like spacer is made of hard plastic and has a uniform thickness. That is, by insertion or non-insertion of one kind of plate-like spacer made of inexpensive hard plastic and having a uniform thickness between the adjacent rectangular cells, variations in the thicknesses of the rectangular cells are absorbed. Therefore, a cell stack which can be manufactured more cost-savingly and easily can be provided.

According to the present disclosure, it is possible to provide a cell stack which can be manufactured more cost-savingly and easily.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a cell stack according to a first embodiment;

FIG. 2 is a perspective view showing a cell stack according to the first embodiment;

FIG. 3 is a side view of a cell stack according to the first embodiment; and

FIG. 4 is a flow chart showing a method of manufacturing a cell stack according to the first embodiment.

### DESCRIPTION OF EMBODIMENTS

Hereinafter, specific embodiments of the present disclosure will be described in detail with reference to the drawings. However, the present disclosure is not limited to the following embodiments. In order to clarify the description, the following description and drawings are simplified as appropriate.

### First Embodiment

### Configuration of Cell Stack

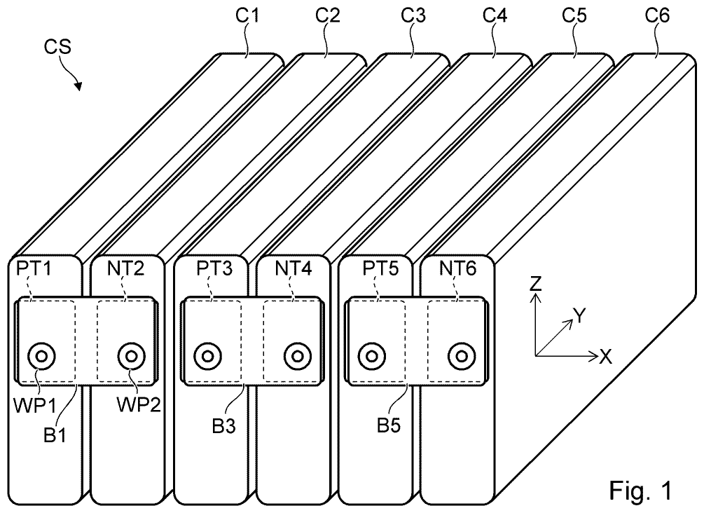

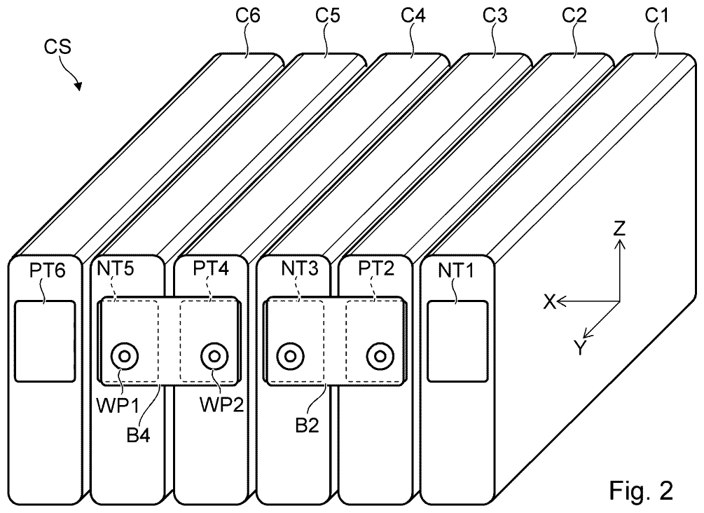

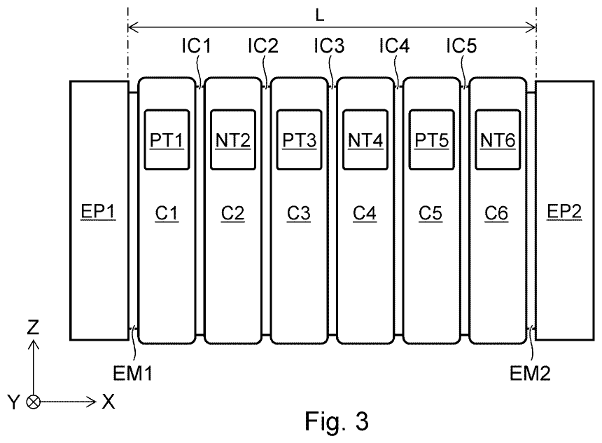

First, a configuration of a cell stack according to a first embodiment will be described with reference to FIGS. 1 to 3. FIGS. 1 and 2 are perspective views showing a cell stack according to the first embodiment. FIG. 3 is a side view showing a cell stack according to the first embodiment.

It should be noted that the right-handed XYZ orthogonal coordinate system shown in FIGS. 1 to 3 is for the sake of convenience in explaining the positional relationship of the structural components. In FIGS. 1 to 3, normally, the Z-axis positive side represents the vertically upward side and the XY plane represents a horizontal plane, which are common among the drawings.

As shown in FIGS. 1 and 2, a cell stack CS according to the present embodiment includes rectangular cells C1 to C6 and bus bars B1 to B5. Further, as shown in FIG. 3, the cell stack CS according to the present embodiment includes intercell members IC1 to IC5, end plates EP1 and EP2, and elastic members EM1 and EM2.

In FIG. 2, the intercell members IC1 to IC5, the end plates EP1 and EP2, and the elastic members EM1 and EM2 shown in FIG. 3 are omitted. FIG. 3 shows a state before installation of bus bars B1 to B5 shown in FIGS. 1 and 2.

The cell stack CS according to the present embodiment is used for automotive batteries, for example. A vehicle in which the cell stack CS according to the present embodiment is mounted is not particularly limited, but is, for example, an electric vehicle, a hybrid vehicle, a fuel cell vehicle, or the like that can be driven by electric power supplied from the cell stack CS.

As shown in FIGS. 1 and 2, the rectangular cells C1 to C6 are rectangular parallelepiped-shaped rectangular cells extending in the Y-axis direction. The cell stack CS is configured by stacking the rectangular cells C1 to C6 in the thickness direction (X-axis direction). The rectangular cells C1 to C6 are, for example, secondary batteries such as lithium-ion batteries, nickel-metal hydride batteries, or the like.

FIGS. 1 and 2 show simplified illustrations of the cell stack CS. The cell stack CS shown in FIGS. 1 and 2 is configured of the six rectangular cells C1 to C6, but the number of the rectangular cells configuring the cell stack CS is not particularly limited. Normally, the cell stack CS is configured of many rectangular cells.

As shown in FIG. 1, a positive electrode terminal PT1 is provided on one end surface of the rectangular cell C1 in the longitudinal direction (Y-axis negative-side end surface). Although not particularly limited, the positive electrode terminal PT1 shown in FIG. 1 has a rectangular shape in the XZ plan view and is provided so as to protrude outward from an end surface of the rectangular cell C1. The positive electrode terminal PT1 shown in FIG. 1 is provided on the upper side (Z-axis positive-side) of an end surface of the rectangular cell C1. The positive electrode terminal PT1 is made of, for example, a metal material such as copper having excellent conductivity.

Similarly, as shown in FIG. 1, a negative electrode terminal NT2 is provided on one end surface of the rectangular cell C2 adjacent to the rectangular cell C1 in the longitudinal direction (Y-axis negative-side end surface). A positive electrode terminal PT3 is provided on one end surface of the rectangular cell C3 adjacent to the rectangular cell C2 in the longitudinal direction (Y-axis negative-side end surface). A negative electrode terminal NT4 is provided on one end surface of the rectangular cell C4 adjacent to the rectangular cell C3 in the longitudinal direction (Y-axis negative-side end surface). A positive electrode terminal PT5 is provided on one end surface of the rectangular cell C5 adjacent to the rectangular cell C4 in the longitudinal direction (Y-axis negative-side end surface). A negative electrode terminal NT6 is provided on one end surface of the rectangular cell C6 adjacent to the rectangular cell C5 in the longitudinal direction (Y-axis negative-side end surface).

As shown in FIG. 1, the negative electrode terminal NT2 of the rectangular cell C2, the positive electrode terminal PT3 of the rectangular cell C3, the negative electrode terminal NT4 of the rectangular cell C4, the positive electrode terminal PT5 of the rectangular cell C5, and the negative electrode terminal NT6 of the rectangular cell C6 have the same shape as that of the positive electrode terminal PT1 of the rectangular cell C1 and are arranged in the same manner.

As shown in FIG. 1, the positive electrode terminal PT1 of the rectangular cell C1 and the negative electrode terminal NT2 of the rectangular cell C2 that are adjacently arranged are electrically connected through the plate-like bus bar B1. Similarly, the positive electrode terminal PT3 of the rectangular cell C3 and the negative electrode terminal NT4 of the rectangular cell C4 that are adjacently arranged are electrically connected through the plate-like bus bar B3. Similarly, the positive electrode terminal PT5 of the rectangular cell C5 and the negative electrode terminal NT6 of the rectangular cell C6 that are adjacently arranged are electrically connected through the plate-like bus bar B5.

On the other hand, as shown in FIG. 2, a negative electrode terminal NT1 is provided on the other end surface in the longitudinal direction of the rectangular cell C1 (Y-axis positive-side end surface). Although not particularly limited, the negative electrode terminal NT1 shown in FIG. 2 has a rectangular shape in the XZ plan view, similar to the positive electrode terminal PT1 shown in FIG. 1, and is provided so as to protrude outward from the end surface of the rectangular cell C1. The negative electrode terminal NT1 shown in FIG. 2 is provided on the upper side (Z-axis positive-side) of the end surface of the rectangular cell C1, similar to the positive electrode terminal PT1 shown in FIG. 1. Like the positive electrode terminal PT1, the negative electrode terminal NT1 is made of a metal material such as copper having excellent conductivity.

Similarly, as shown in FIG. 2, a positive electrode terminal PT2 is provided on the other end surface of the rectangular cell C2 adjacent to the rectangular cell C1 in the longitudinal direction (Y-axis positive-side end surface). A negative electrode terminal NT3 is provided on the other end surface of the rectangular cell C3 adjacent to the rectangular cell C2 in the longitudinal direction (Y-axis positive-side end surface). A positive electrode terminal PT4 is provided on the other end surface of the rectangular cell C4 adjacent to the rectangular cell C3 in the longitudinal direction (Y-axis positive-side end surface). A negative electrode terminal NT5 is provided on the other end surface of the rectangular cell C5 adjacent to the rectangular cell C4 in the longitudinal direction (Y-axis positive-side end surface). A positive electrode terminal PT6 is provided on the other end surface of the rectangular cell C6 adjacent to the rectangular cell C5 in the longitudinal direction (Y-axis positive-side end surface).

As shown in FIG. 2, the positive electrode terminal PT2 of the rectangular cell C2, the negative electrode terminal NT3 of the rectangular cell C3, the positive electrode terminal PT4 of the rectangular cell C4, the negative electrode terminal NT5 of the rectangular cell C5, and the positive electrode terminal PT6 of the rectangular cell C6 have the same shape as that of the negative electrode terminal NT1 of the rectangular cell C1 and are arranged in the same manner.

As shown in FIG. 2, the positive electrode terminal PT2 of the rectangular cell C2 and the negative electrode terminal NT3 of the rectangular cell C3 that are adjacently arranged are electrically connected through the plate-like bus bar B2. Similarly, the positive electrode terminal PT4 of the rectangular cell C4 and the negative electrode terminal NT5 of the rectangular cell C5 that are adjacently arranged are electrically connected through the plate-like bus bar B4.

Thus, in the cell stack CS shown in FIGS. 1 and 2, the rectangular cells C1 to C6 are connected in series through the bus bars B1 to B5.

The negative electrode terminal NT1 of the rectangular cell C1 shown in FIG. 2 is not particularly limited, but is connected to a positive electrode terminal of another cell stack via, for example, a bus bar (not shown). The positive electrode terminal PT6 of the rectangular cell C6 shown in FIG. 2 is not particularly limited, but is connected to a negative electrode terminal of further another cell stack via, for example, a bus bar (not shown). With such a configuration, for example, a plurality of cell stacks can be connected in series.

Since the bus bars B1 to B5 shown in FIGS. 1 and 2 have the same configuration, description on the bus bar B1 will be given.

As shown in FIG. 1, the bus bar B1 is a plate-like member that electrically connects the positive electrode terminal PT1 of the rectangular cell C1 and the negative electrode terminal NT2 of the rectangular cell C2 that are adjacently arranged. The bus bar B1 is made of, for example, a metal material such as copper having excellent conductivity.

As shown in FIG. 1, the bus bar B1 is, for example, a plate-like member having a rectangular shape in the XZ plan view. The bus bar B1 is provided so as to cover substantially the whole of the positive electrode terminal PT1 of the rectangular cell C1 and the negative electrode terminal NT2 of the rectangular cell C2. The bus bar B1 is provided with a pair of welded parts WP1 and WP2 that are adjacently arranged, in which the positive electrode terminal PT1 of the rectangular cell C1 and the negative electrode terminal NT2 of the rectangular cell C2 are welded, respectively.

Although not particularly limited, the welded parts WP1 and WP2 shown in FIG. 1 are provided in both end parts of the bus bar B1 on the lower side thereof in the X-axis direction (Z-axis negative side). Here, FIG. 1 shows the welded parts WP1 and WP2 before welding. The welded parts WP1 and WP2 shown in FIG. 1 are countersunk and are thinner than other areas. The welded parts WP1 and WP2 shown in FIG. 1 have a circular shape in the XZ plan view and have a through hole in the respective centers thereof.

The welding method is not particularly limited, but for example, the bus bar B1 is welded to the positive electrode terminal PT1 of the rectangular cell C1 in the welded part WP1 by irradiating a laser beam on the welded part WP1 from the Y-axis negative side. Similarly, the bus bar B1 is welded to the negative electrode terminal NT2 of the rectangular cell C2 in the welded part WP2 by irradiating the welded part WP2 with a laser beam from the Y-axis negative side.

As shown in FIG. 3, the intercell members IC1 to IC5 are plate-like members inserted between the adjacent rectangular cells C1 to C6. As shown in FIG. 3, for example, the intercell member IC1 is inserted between the adjacent rectangular cells C1 and C2. The intercell member IC1 serves to heat-insulate the adjacent rectangular cells C1 and C2 from each other and to adjust the spacing between the adjacent rectangular cells C1 and C2.

More specifically, each of the intercell members IC1 to IC5 is either a first intercell member including a plate-like spacer for absorbing variations in the thicknesses of the rectangular cells C1 to C6 or a second intercell member not including the plate-like spacer. Here, the plate-like spacer is made of hard plastic and has a uniform thickness.

The rectangular cells C1 to C6 have a predetermined dimension tolerance ±b with respect to the design thickness a. That is, the thickness of the rectangular cells C1 to C6 is a±b.

Each of the intercell members IC1 to IC5 (i.e., the first intercell member and the second intercell member) may include a heat insulating plate having a uniform thickness.

Whether the first intercell member or the second intercell member is to be used for the intercell members IC1 to IC5 is decided upon manufacturing the cell stack CS.

In the case of sequentially stacking the rectangular cells C1 to C6, each time a rectangular cell is stacked, the thickness of the rectangular cell to be stacked is measured and a determination is made as to whether the total thickness obtained by adding the measured thickness of the rectangular cell to be stacked to the thicknesses of the already-stacked rectangular cells and the thickness of the intercell member exceeds a predetermined reference value.

For example, in the case of stacking the rectangular cell C3, a determination is made as to whether the total thickness obtained by adding the measured thickness of the rectangular cell C3 to the thicknesses of the already-stacked rectangular cells C1 and C2 and the intercell member IC1 exceeds a predetermined reference value. A reference value of the total thickness is determined in advance for each of the second and subsequent rectangular cells C2 to C6 to be stacked. For example, a reference value is appropriately decided based on the design thickness a of a rectangular cell, the dimensional tolerance ±b, the design thickness of a heat insulating plate, etc.

In a case where the total thickness does not exceed the reference value, the first intercell member including the plate-like spacer is inserted as the intercell member IC2, and then the rectangular cell C3 is stacked. On the other hand, in the case where the total thickness exceeds the reference value, the second intercell member not including the plate-like spacer is inserted as the intercell member IC2, and then the rectangular cell C3 is stacked. The same applies in the case of stacking the other rectangular cells C2, and C4 to C6.

As a result, in the cell stack CS according to this embodiment, the first intercell member including the plate-like spacer and the second intercell member not including the plate-like spacer are arranged at irregular intervals as the intercell members IC1 to IC5.

Here, by appropriately setting the reference value of the total thickness and bringing the thickness of the plate-like spacer to be equal to the dimensional tolerance range 2b of each rectangular cell, the amount of deviation of the central position of the rectangular cells C1 to C6 shown in FIG. 3 from the target position can be reduced to a value equal to or below the absolute value b of the dimensional tolerance ±b or less. Also, the length of the rectangular cells C1 to C6 stacked via the intercell members IC1 to IC5 can be brought close to the target value.

As shown in FIG. 3, the end plate EP1 is arranged via the elastic member EM1 in the X-axis negative-side end part of the rectangular cells C1 to C6 stacked via the intercell members IC1 to IC5. The end plate EP2 is arranged via the elastic member EM2 in the X-axis positive-side end part of the stacked rectangular cells C1 to C6. That is, the end plates EP1 and EP2 bind the stacked rectangular cells C1 to C6 by pressing them from both ends in the stacking direction (X-axis direction). The end plates EP1 and EP2 are made of a metal material such as aluminum.

The elastic members EM1 and EM2 are plate-like members made of an elastic material such as elastomer containing synthetic rubber.

Here, a length L in the cell stack CS shown in FIG. 3 denotes a distance between the inner surfaces of the end plates EP1 and EP2, which is a fixed value. Deviation from the target value of the length of the rectangular cells C1 to C6 stacked via the intercell members IC1 to IC5 can be absorbed by the elastic members EM1 and EM2.

As described above, in the cell stack CS according to the present embodiment, one kind of plate-like spacer made of inexpensive hard plastic and having a uniform thickness is inserted at irregular intervals between the adjacent rectangular cells C1 to C6, thereby variations in the thicknesses of the rectangular cells C1 to C6 are absorbed. Therefore, the cell stack CS according to the present embodiment can be manufactured more cost-savingly and easily than the cell stack in which two kinds of plate-like spacers made of an elastic material having different thicknesses are selectively inserted between all adjacent rectangular cells.

### Method of Manufacturing Cell Stack

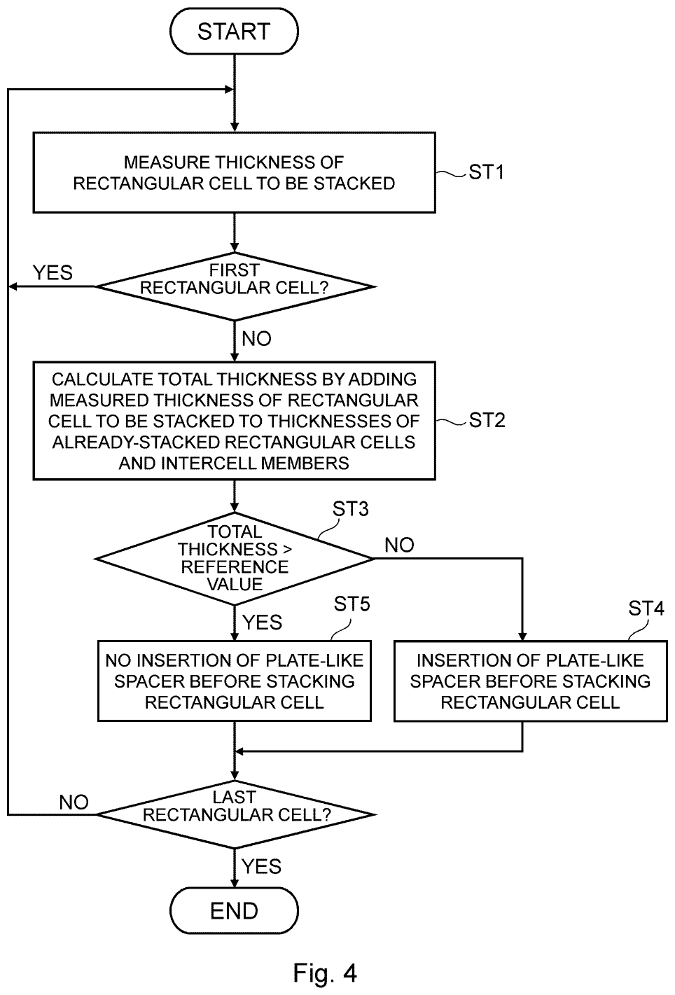

Next, a method of manufacturing a cell stack according to the first embodiment will be described with reference to FIG. 4. FIG. 4 is a flowchart showing a method of manufacturing a cell stack according to the first embodiment. Specifically, the rectangular cells C1 to C6 and the intercell members IC1 to IC5 shown in FIG. 3 are sequentially stacked to thereby manufacture the cell stack CS having a rectangular parallelepiped shape.

First, as shown in FIG. 4, the thickness of the rectangular cell to be stacked is measured (Step ST1). Specifically, the thickness of the rectangular cell C1 to be stacked is measured.

Next, as shown in FIG. 4, in the case where the rectangular cell to be stacked is the first rectangular cell, the process exceptionally returns to Step ST1, and in the case where the rectangular cell to be stacked is not the first rectangular cell, the total thickness is calculated by adding the measured thickness of the rectangular cell to be stacked to the thicknesses of the already-stacked rectangular cells and the thicknesses of the intercell members (Step ST2).

More specifically, after the thickness of the rectangular cell Cl which is the first rectangular cell to be stacked is measured, the process returns to Step ST1, and the thickness of the rectangular cell C2 is measured. Subsequently, the process proceeds to Step ST2, and the total thickness is calculated by adding the measured thickness of the rectangular cell C2 to the thickness of the already-stacked rectangular cell C1.

Next, as shown in FIG. 4, determination is made as to whether the total thickness exceeds the predetermined reference value (Step ST3). In the case where the total thickness does not exceed the predetermined reference value (NO in Step ST3), the first intercell member including the plate-like spacer for absorbing variations in the thicknesses of the rectangular cells is inserted as an intercell member and then a rectangular cell is stacked (Step ST4). Specifically, the first intercell member including plate-like spacer is inserted as the intercell member IC1, and then the rectangular cell C2 is stacked. Here, the plate-like spacer is made of hard plastic and has a uniform thickness.

On the other hand, in the case where the total thickness exceeds the predetermined reference value (YES in Step ST3), the second intercell member not including the plate-like spacer is inserted as the intercell member, and then a rectangular cell is stacked (Step ST5). Specifically, the second intercell member not including the plate-like spacer is inserted as the intercell member IC1, and then the rectangular cell C2 is stacked.

As shown in FIG. 4, after stacking a rectangular cell in in Step ST4 or Step ST5, in the case where the stacked rectangular cell is not the last rectangular cell to be stacked, the process returns to Step ST1. On the other hand, in the case where the stacked rectangular cell is the last rectangular cell to be stacked, the process ends. Specifically, since the stacked rectangular cell C2 is not the last rectangular cell to be stacked, the process returns to Step ST1 and the thickness of the rectangular cell C3 to be stacked is measured.

Next, as shown in FIG. 4, the process proceeds to Step ST2. Specifically, the total thickness is calculated by adding the measured thickness of the rectangular cell C3 to the thicknesses of the already-stacked rectangular cells C1 and C2 and the intercell member IC1.

Next, as shown in FIG. 4, in the case where the total thickness does not exceed the predetermined reference value (NO in Step ST3), the process proceeds to Step ST4. Specifically, the first intercell member including the plate-like spacer is inserted as the intercell member IC2, and then the rectangular cell C3 is stacked. On the other hand, in the case where the total thickness exceeds the predetermined reference value (YES in Step ST3), the process proceeds to Step ST5. Specifically, the second intercell member not including the plate-like spacer is inserted as the intercell member IC2, and then the rectangular cell C3 is stacked.

Then, as shown in FIG. 4, after the rectangular cell C3 is stacked in Step ST4 or Step ST5, the process returns to Step ST1, and then the thickness of the rectangular cell C4 to be stacked is measured.

Thus, Steps ST1 to ST5 are repeated to sequentially stack the rectangular cells C1 to C6 and the intercell members IC1 to IC5 until the last rectangular cell C6 is stacked, whereby the cell stack CS is manufactured.

As described above, in the method of manufacturing a stack according to the present embodiment, by insertion or non-insertion of one kind of plate-like spacer made of inexpensive hard plastic and having a uniform thickness between the adjacent rectangular cells, variations in the thicknesses of the rectangular cells are absorbed. Therefore, in the method of manufacturing a cell stack according to the present embodiment, a cell stack can be manufactured more cost-savingly and easily than a method in which two kinds of plate-like spacers made of elastic material and having different thicknesses are selectively inserted between all adjacent rectangular cells.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A cell stack comprising:
a plurality of rectangular cells that are stacked; and
a plurality of intercell members inserted between the adjacent rectangular cells, the cell stack having a rectangular parallelepiped shape,
wherein the plurality of the intercell members comprise:
a first intercell member including a plate-like spacer for absorbing variations in thicknesses of the plurality of rectangular cells; and
a second intercell member not including the plate-like spacer,
wherein the plate-like spacer is made of hard plastic and has a uniform thickness, and
wherein the first intercell member and the second intercell member are arranged at irregular intervals.

2. The cell stack according to claim 1, wherein each of the first and second intercell members includes a heat insulating plate having a uniform thickness.

3. The cell stack according to claim 1, wherein the thickness of each plate-like spacer is equal to a dimensional tolerance range of the thickness of an individual rectangular cell of the plurality of rectangular cells.

4. A method of manufacturing a cell stack having a rectangular parallelepiped shape in which rectangular cells and intercell members are sequentially stacked, comprising:
each time a rectangular cell is to be stacked, measuring a thickness of the rectangular cell to be stacked;
making a determination as to whether a total thickness calculated by adding the measured thickness of the rectangular cell to be stacked to thicknesses of the already-stacked rectangular cells and the intercell members exceeds a predetermined reference value;
in the case where the total thickness does not exceed the predetermined reference value, inserting a first intercell member including a plate-like spacer for absorbing variations in the thicknesses of the rectangular cells as an intercell member, and then stacking the rectangular cell to be stacked; and
in the case where the total thickness exceeds the predetermined reference value, inserting a second intercell member not including the plate-like spacer as the intercell member, and then stacking the rectangular cell to be stacked,
wherein the plate-like spacer is made of hard plastic and has a uniform thickness.
